(19) United States
(12) Patent Application Publication
(10) Pub. No.: US 2025/0263956 A1
(43) Pub. Date: Aug. 21, 2025

(54) LID OPENING AND CLOSING SYSTEM

(71) Applicant: AISIN CORPORATION, Kariya (JP)

(72) Inventors: Kimihide KATO, Kariya-shi (JP); Kazuma Kuroyanagi, Kariya-shi (JP); Takayuki Sengoku, Kariya-shi (JP); Hayato Ono, Kariya-shi (JP); Masafumi Suzuki, Kariya-shi (JP); Hideo Morimoto, Kariya-shi (JP); Haruma Hiromura, Kariya-shi (JP)

(73) Assignee: AISIN CORPORATION, Kariya (JP)

(21) Appl. No.: 19/042,776

(22) Filed: Jan. 31, 2025

(30) Foreign Application Priority Data
Feb. 16, 2024 (JP) 2024-021790
Nov. 19, 2024 (JP) 2024-201778

(51) Int. Cl. E05B 81/06; E05B 81/16; E05B 83/18

(52) U.S. Cl. CPC E05B 81/06; E05B 81/16; E05B 83/18

(57) ABSTRACT

A lid opening and closing system opens, closes and locks a lid supported by a vehicle body of a vehicle. The lid opening and closing system includes: a lock device configured to bring the lid into any one of a locked state, a half-locked state, and a lock-released state; an opening and closing drive device configured to open and close the lid; and a control device configured to control the lock device to transition the lid from the locked state to the lock-released state via the half-locked state in response to an opening command of the lid, and configured to control the opening and closing drive device to pull-in the lid toward a closing side while the lock device operates to transition the lid from the locked state to the half-locked state.

### CROSS REFERENCE TO RELATED APPLICATIONS

This application is based on and claims priority under 35 U.S.C. § 119 to Japanese Patent Application 2024-021790, filed on Feb. 16, 2024, and Japanese Patent Application 2024-201778, filed on Nov. 19, 2024, the entire content of which is incorporated herein by reference.

### TECHNICAL FIELD

This disclosure relates to a lid opening and closing system that opens and closes and locks a lid supported by a vehicle body of a vehicle.

### BACKGROUND DISCUSSION

In the related art, a control device that controls an actuator for releasing a lock of a slide door, which is an opening and closing body of a vehicle, is known (for example, see JP H04-68182U (Reference 1)). When the lock of the slide door is released, the control device controls a drive device different from the actuator so as to forcibly move the slide door to an over stroke position on a closing side with respect to a fully-closed position. Then, the control device controls the actuator to release the lock of the slide door after the control device detects that the slide door reaches the over stroke position. Accordingly, since a reaction force acting on the slide door from a seal member of an opening closed by the slide door is reduced, it is possible to prevent generation of collision noise and sliding noise between members and to reduce a force required for releasing the lock.

Here, when the above-described technique in the related art is applied to a lid or a hood of a trunk disposed in a vehicle and the lid is moved to a closing side before an actuator for releasing a lock is operated, a time from issuance of an opening command of the lid to release of the lock is prolonged. Further, with respect to the lid or the like of the trunk disposed in the vehicle, it is required to prevent the generation of the abnormal noise such as the collision noise between the members when a first stage lock is released.

A need thus exists for a lid opening and closing system which is not susceptible to the drawback mentioned above.

### SUMMARY

A lid opening and closing system according to this disclosure is a lid opening and closing system that opens, closes and locks a lid supported by a vehicle body of a vehicle, and the lid opening and closing system includes: a lock device configured to bring the lid into any one of a locked state, a half-locked state, and a lock-released state; an opening and closing drive device configured to open and close the lid; and a control device configured to control the lock device to transition the lid from the locked state to the lock-released state via the half-locked state in response to an opening command of the lid, and configured to control the opening and closing drive device to pull-in the lid toward a closing side while the lock device operates to transition the lid from the locked state to the half-locked state.

Another lid opening and closing system according to this disclosure is a lid opening and closing system that opens, closes and locks a lid supported by a vehicle body of a vehicle, and the lid opening and closing system includes: a lock device configured to bring the lid into any one of a locked state, a half-locked state, and a lock-released state; an opening and closing drive device configured to open and close the lid; and a control device configured to control the lock device to transition the lid from the locked state to the lock-released state via the half-locked state in response to an opening command of the lid, configured to control the lock device to transition the lid from the locked state to the lock-released state via the half-locked state when the lid returns to the locked state again after the lock device transitions the lid from the locked state to the half-locked state, and configured to control the opening and closing drive device to transition the lid to an opening side.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram showing a vehicle to which a lid opening and closing system disclosed here is applied;

FIG. 2 is a schematic configuration diagram showing the lid opening and closing system disclosed here;

FIG. 3 is a plan view showing a latch provided in a lock device of the lid opening and closing system disclosed here;

FIG. 4 is a plan view showing a pole provided in the lock device of the lid opening and closing system disclosed here;

FIG. 5 is a plan view showing states of the latch and the pole in a lock-released state;

FIG. 6 is a plan view showing states of the latch and the pole in a half-locked state;

FIG. 7 is a plan view showing states of the latch and the pole in a locked state;

FIG. 8 is a flowchart showing a routine executed by a control device of the lid opening and closing system disclosed here;

FIG. 9 is a time chart showing an example of states of first, second, and third switches, a closer motor, and an opening and closing drive device while the routine in FIG. 8 is executed; and

FIG. 10 is a time chart showing another example of the states of the first, second, and third switches, the closer motor, and the opening and closing drive device while the routine in FIG. 8 is executed.

### DETAILED DESCRIPTION

Hereinafter, an embodiment disclosed here will be described with reference to the drawings.

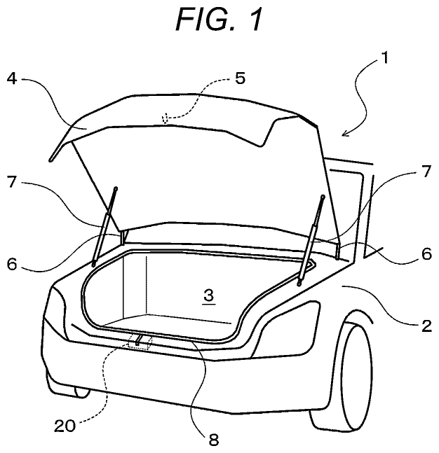

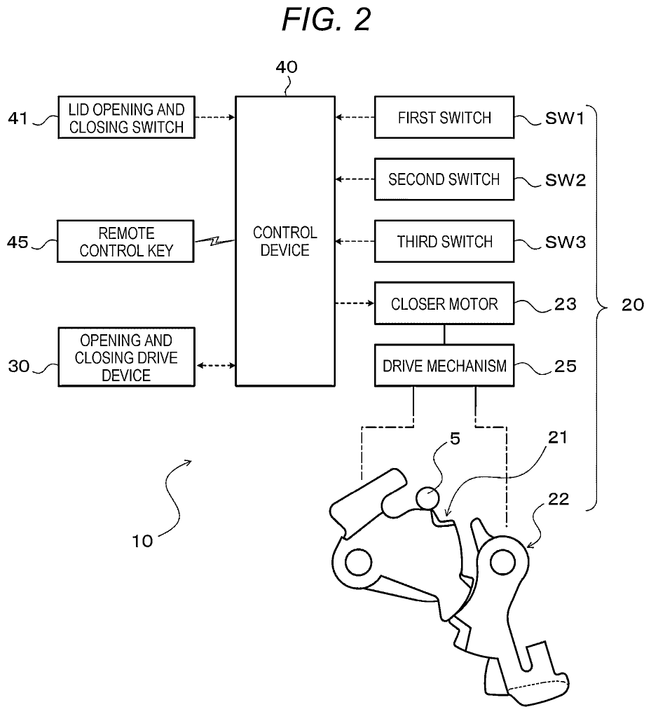

FIG. 1 is a schematic configuration diagram showing a vehicle 1 to which a lid opening and closing system 10 disclosed here is applied, and FIG. 2 is a schematic configuration diagram showing the lid opening and closing system 10. The vehicle 1 shown in FIG. 1 includes a front trunk (flank) 3 provided in a vehicle body 2 and a lid (flank hood) 4 covering an opening of the front trunk 3. The lid 4 includes a striker 5 fixed to an inner surface of a front end portion thereof, and is rotatably supported by the vehicle body 2 via a pair of hinges 6 and a pair of extendable support members 7, such that the front end portion opens and closes vertically. Alternatively, the lid 4 may be rotatably supported by the vehicle body 2, such that a rear end portion opens and closes vertically. A weather strip (seal member) 8 formed of an elastic body such as rubber or resin is attached to the vehicle body 2 along the opening of the front trunk 3 so as to abut against the inner surface of the lid 4.

As shown in FIG. 2, the lid opening and closing system 10 includes a lock device 20 that locks the closed lid 4, an opening and closing drive device 30 that opens and closes the lid 4, and a control device 40 that controls the lock device 20 and the opening and closing drive device 30. The lock device 20 is provided in the vehicle body 2 so as to be engageable with the striker 5 of the closed lid 4. The opening and closing drive device 30 includes an electric motor (not shown) and the like, and is provided in the vehicle body 2 so as to extend and contract the pair of support members 7 to open and close the lid 4.

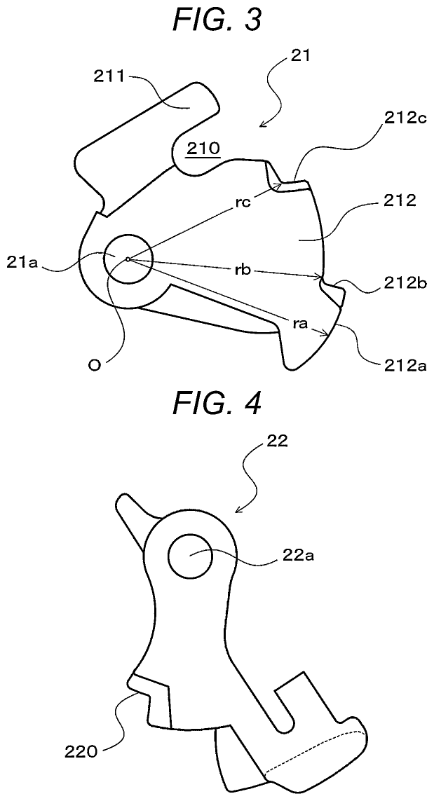

As shown in FIG. 2, the lock device 20 includes a latch 21, a pole 22, a closer motor 23, a drive mechanism 25, a first switch SW1, a second switch SW2, and a third switch SW3. The latch 21 is rotatable around a rotation shaft 21a fixed to a base member (vehicle body 2) (not shown) of the lock device 20 attached to the vehicle body 2, and as shown in FIG. 3, includes a notch portion 210 engageable with the striker 5 of the lid 4, and a first claw portion 211 and a second claw portion 212 defining the notch portion 210.

The second claw portion 212 of the latch 21 is formed with an open engagement surface 212a, a half-locked engagement surface (half-locked engagement portion) 212b, and a full-locked engagement surface (full-locked engagement portion) 212c. The open engagement surface 212a, the half-locked engagement surface 212b, and the full-locked engagement surface 212c are formed on an outer peripheral portion of the second claw portion 212 so as to be arranged in this order in a counterclockwise direction in FIG. 3. The open engagement surface 212a is a cylindrical surface centered on a center axis O of the rotation shaft 21a. The half-locked engagement surface 212b and the full-locked engagement surface 212c are flat surfaces extending in a radial direction of the latch 21. As shown in FIG. 3, a distance ra from the center axis O of the rotation shaft 21a to the open engagement surface 212a is larger than a distance rb from the center axis O to an end portion of the half-locked engagement surface 212b on a rotation shaft 21a side, and the distance rb is larger than a distance rc from the center axis O to an end portion of the full-locked engagement surface 212c on the rotation shaft 21a side. The latch 21 is biased in a direction (counterclockwise direction in FIG. 3) in which the striker 5 is opened around the rotation shaft 21a against the base member by a latch spring (not shown).

The pole 22 is rotatable around a rotation shaft 22a fixed to the base member described above so as to extend parallel to the rotation shaft 21a of the latch 21, and as shown in FIG. 4, includes an engagement portion 220. The engagement portion 220 extends in a radial direction of the rotation shaft 22a so as to be selectively engageable with the open engagement surface 212a, the half-locked engagement surface 212b, and the full-locked engagement surface 212c of the latch 21. Further, the pole 22 is biased in a clockwise direction in FIG. 3 around the rotation shaft 22a against the base member by a pole spring (not shown).

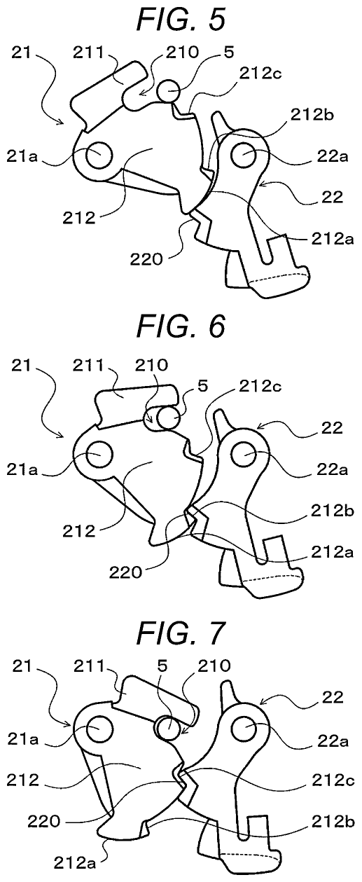

As shown in FIG. 5, when an end portion of the engagement portion 220 of the pole 22 abuts against the open engagement surface 212a of the latch 21, the engagement between the striker 5 and the notch portion 210 of the latch 21 is released, and the lid 4 is maintained in a lock-released state. As shown in FIG. 6, when the engagement portion 220 of the pole 22 is engaged with the half-locked engagement surface 212b of the latch 21 to form a half-latched state, the lid 4 is maintained in a half-locked state in which the striker 5 is pulled-in by the first claw portion 211 of the latch 21 and is slightly opened. Further, as shown in FIG. 7, when the engagement portion 220 of the pole 22 is engaged with the full-locked engagement surface 212c of the latch 21 to form a full-latched state, the lid 4 is maintained in a locked state (fully closed state) in which the striker 5 is completely pulled-in downward in the drawing by the first claw portion 211 of the latch 21.

The closer motor 23 is, for example, a DC brushless motor. The drive mechanism 25 includes a speed reduction mechanism coupled to the closer motor 23, a sector gear rotated by the closer motor 23 via the speed reduction mechanism, and a plurality of links that selectively rotate one of the latch 21 and the pole 22 in conjunction with the rotation of the sector gear. In the present embodiment, when the sector gear is rotated by the closer motor 23 in one direction by a predetermined angle in the full-latched state in which the engagement portion 220 of the pole 22 is engaged with the full-locked engagement surface 212c of the latch 21, the drive mechanism 25 rotates the pole 22 around the rotation shaft 22a in the counterclockwise direction in FIGS. 5 to 7 such that the engagement portion 220 is engaged with the half-locked engagement surface 212b of the latch 21 biased around the rotation shaft 21a in the counterclockwise direction in FIGS. 5 to 7 by the latch spring.

When the sector gear is returned to an initial position (origin position) by the closer motor 23 in the half-latched state in which the engagement portion 220 of the pole 22 is engaged with the half-locked engagement surface 212b of the latch 21 and then is rotated again by the predetermined angle in the one direction described above, the drive mechanism 25 rotates the latch 21 around the rotation shaft 21a in the counterclockwise direction in FIGS. 5 to 7 such that the engagement between the half-locked engagement surface 212b and the engagement portion 220 of the pole 22 biased around the rotation shaft 22a in the clockwise direction in FIGS. 5 to 7 by the pole spring is released. Further, when the sector gear is rotated in the one direction described above by the closer motor 23 by the predetermined angle in the state in which the engagement between the striker 5 and the notch portion 210 of the latch 21 is released, the drive mechanism 25 rotates the latch 21 around the rotation shaft 21a in the clockwise direction in FIGS. 5 to 7 such that the full-locked engagement surface 212c engages with the engagement portion 220 after the half-locked engagement surface 212b of the latch 21 engages with the engagement portion 220 of the pole 22.

Further, after an opening command of the lid 4 is issued, based on a position of the link that moves in response to the rotation of the sector gear of the drive mechanism 25, the first switch SW1 of the lock device 20 outputs a low-level off signal when the formation of the full-latched state in which the full-locked engagement surface 212c of the latch 21 and the engagement portion 220 of the pole 22 are engaged with each other is detected, and outputs a high-level on signal when release of the full-latched state is detected. After the full-latched state is released and the sector gear is returned to the initial position, based on the position of the link that moves in response to the rotation of the sector gear of the drive mechanism 25, the first switch SW1 outputs the low-level off signal when the formation of the half-latched state in which the half-locked engagement surface 212b of the latch 21 and the engagement portion 220 of the pole 22 are engaged with each other is detected, and outputs the high-level on signal when release of the half-latched state is detected.

Based on the position of the pole 22, the second switch SW2 outputs the low-level off signal when the full-latched state is formed, and when a transition from the full-latched state to the half-latched state in which the half-locked engagement surface 212b of the latch 21 and the engagement portion 220 of the pole 22 are engaged with each other is detected, the second switch SW2 continuously outputs the high-level on signal thereafter. When a transition from the half-latched state to the full-latched state is detected after the formation of the half-latched state, the second switch SW2 continuously outputs the low-level off signal thereafter. The third switch SW3 outputs the low-level off signal when the sector gear of the drive mechanism 25 is at the initial position (origin), and outputs the high-level on signal when the sector gear is at a position other than the initial position.

The control device 40 includes a microcomputer including a CPU, a ROM, a RAM, and the like, a motor drive circuit, a communication module, a storage device, and the like, which are not shown. The first switch SW1, second switch SW2, and third switch SW3 described above, rotation sensors (not shown) of the closer motor 23 and the electric motor of the opening and closing drive device 30, a lid opening and closing switch 41 provided in an vehicle interior or the like of the vehicle 1, an emergency switch (not shown) provided in the front trunk 3, and the like are connected to the control device 40. Further, the control device 40 can receive a signal transmitted from a wireless remote control key (smart key) 45 including an opening switch and a closing switch for opening and closing the lid 4, a lock switch, a lock-releasing switch, and the like. When a user operates the remote control key 45 or the like, the control device 40 controls the closer motor 23 of the lock device 20, the electric motor of the opening and closing drive device 30, and the like so as to open and close the lid 4 based on detection values of various sensors.

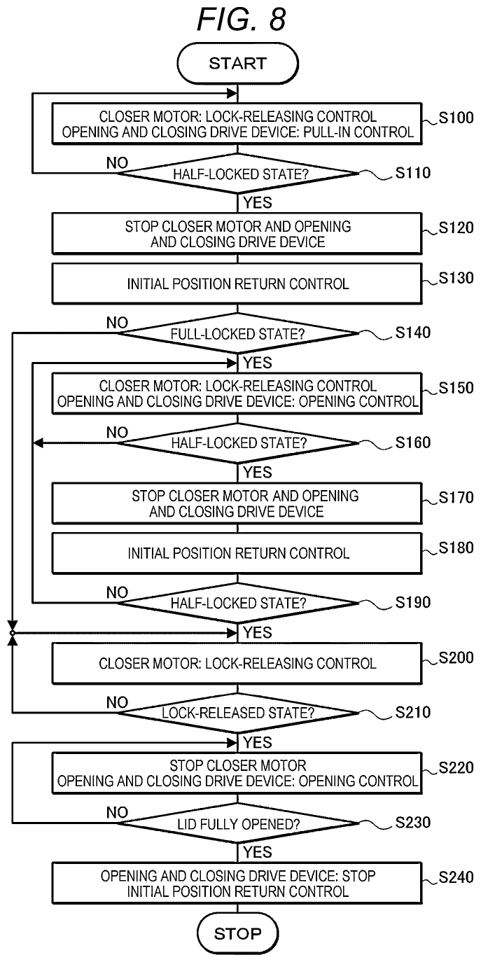

Next, a procedure for opening the lid 4 in the locked state in response to an operation of the lid opening and closing switch 41 or the remote control key 45 by the user of the vehicle 1 will be described with reference to FIGS. 8 to 10.

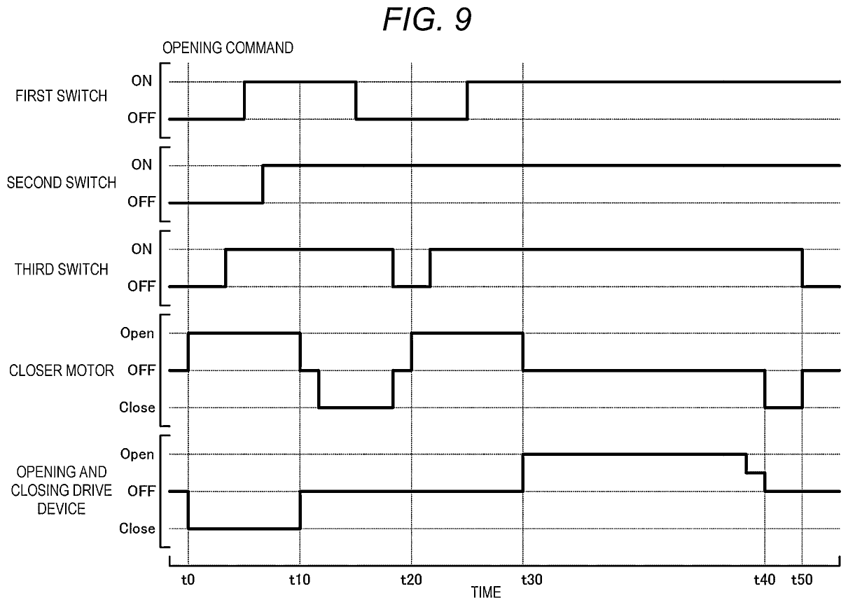

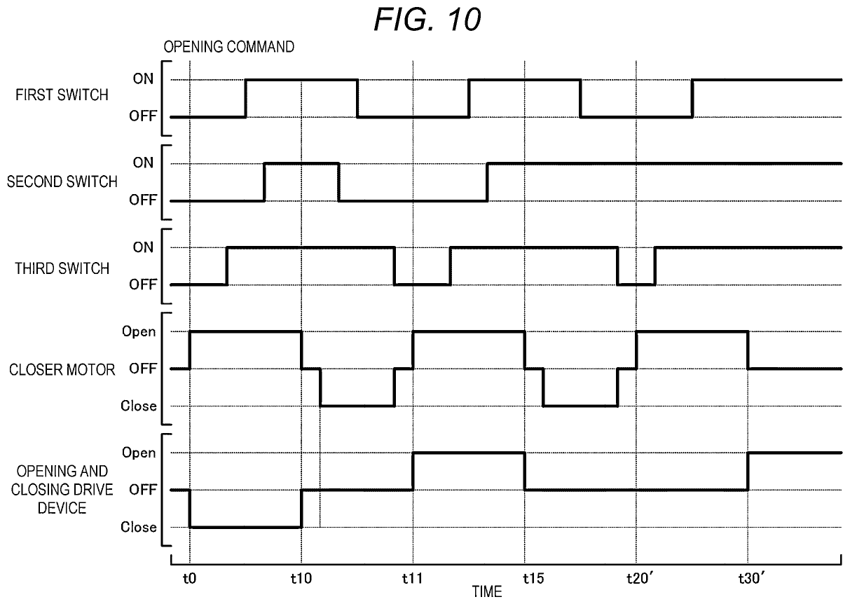

FIG. 8 is a flowchart showing a routine executed by the control device 40 when an opening command signal of the lid 4 is issued from the lid opening and closing switch 41 or the remote control key 45, and FIGS. 9 and 10 are time charts showing states of the first switch SW1, second switch SW2, and third switch SW3, the closer motor 23, and the opening and closing drive device 30 while the routine in FIG. 8 is executed. When the opening command signal of the lid 4 is issued from the lid opening and closing switch 41 or the like (time point t0 in FIGS. 9 and 10), the control device 40 starts lock-releasing control of the closer motor 23 and pull-in control of the opening and closing drive device 30 (step S100), and determines whether the lid 4 is in the half-locked state (step S110). The pull-in control of the opening and closing drive device 30 may be started at a timing slightly delayed from the start (the start of rotation of the closer motor 23) of the lock-releasing control of the closer motor 23.

The lock-releasing control of the closer motor 23 in step S100 controls the closer motor 23 so as to rotate the sector gear of the drive mechanism 25 in the one direction described above by the predetermined angle. Accordingly, when the process of step S100 is started, the pole 22 is rotated in the counterclockwise direction in FIGS. 5 to 7 around the rotation shaft 22a by the closer motor 23 via the drive mechanism 25. The pull-in control of the opening and closing drive device 30 controls the electric motor of the opening and closing drive device 30 so as to pull-in the lid 4 to a closing side at the same time as or immediately after the start of the operation of the closer motor 23. The pull-in control may be a voltage gradual change process of gradually increasing a voltage applied to the electric motor of the opening and closing drive device 30 with a lapse of time from the start of the process of step S100, or may be a process of stopping the pull-in of the lid 4 when a rotation amount of the electric motor reaches a predetermined value after the start of the process of step S100.

In step S110, the control device 40 determines whether a predetermined first time tref1 elapses after the first switch SW1 detects the release of the full-latched state in which the full-locked engagement surface 212c of the latch 21 and the engagement portion 220 of the pole 22 are engaged with each other. Further, in step S110, the control device 40 determines whether a predetermined second time tref2 elapses after the second switch SW2 detects the formation of the half-latched state in which the half-locked engagement surface 212b of the latch 21 and the engagement portion 220 of the pole 22 are engaged with each other. In addition, in step S110, the control device 40 determines whether a drive state of the closer motor 23 indicates that the engagement between the full-locked engagement surface 212c and the pole 22 is released. In the present embodiment, when a value of a current applied to the closer motor 23 is increased by a predetermined value or more, the control device 40 determines that the sector gear of the drive mechanism 25 reaches a terminal end in the one direction described above and the engagement between the full-locked engagement surface 212c and the pole 22 is released.

When the first time tref1 does not elapse from the release of the full-latched state, the second time tref2 does not elapse from the formation of the half-latched state, and the drive state of the closer motor 23 does not indicate that the engagement between the full-locked engagement surface 212c and the pole 22 is released (step S110: NO), the control device 40 continuously executes the lock-releasing control of the closer motor 23 and the pull-in control of the opening and closing drive device 30 in step S100. When the first time tref1 elapses from the release of the full-latched state, when the second time tref2 elapses from the formation of the half-latched state, or when the drive state of the closer motor 23 indicates that the engagement between the full-locked engagement surface 212c and the pole 22 is released (step S110: YES), the control device 40 stops the closer motor 23 and the electric motor of the opening and closing drive device 30 (step S120, time point t10 in FIGS. 9 and 10).

When the closer motor 23 and the electric motor of the opening and closing drive device 30 are stopped, the half-latched state is formed in which the engagement portion 220 of the pole 22 biased by the pole spring is engaged with the half-locked engagement surface 212b of the latch 21 biased by the latch spring, and the lid 4 is maintained in the half-locked state in which the striker 5 is pulled-in by the first claw portion 211 of the latch 21 and is slightly opened. When the half-latched state is formed, the second switch SW2 continues to output the high-level on signal thereafter. After the process of step S120, the control device 40 executes initial position return control for controlling the closer motor 23 to return the sector gear of the drive mechanism 25 to the initial position (origin position) (step S130). When the sector gear rotates and returns to the initial position, as shown in FIGS. 9 and 10, the first switch SW1 and third switch SW3 output the off signals.

After the initial position return control is completed, the control device 40 determines whether the lid 4 is in the locked state based on the signals from the first switch SW1, second switch SW2, and third switch SW3 (step S140). In step S140, the control device 40 determines that the lid 4 is in the half-locked state when the second switch SW2 outputs the on signal, and determines that the lid 4 is in the locked state when all of the first switch SW1, second switch SW2, and third switch SW3 output the off signals. Here, when snow is loaded on the lid 4 or a baggage is placed on the lid 4, the lid 4 may return to the locked state due to a load from the loaded snow, the baggage, or the like even if the lid 4 is temporarily transitioned to the half-locked state by the lock-releasing control of the closer motor 23. Therefore, when it is determined that the lid 4 is in the locked state (step S140: YES, time point t11 in FIG. 10), the control device 40 starts the lock-releasing control of the closer motor 23 and opening control of the opening and closing drive device 30 (step S150), and determines whether the lid 4 is in the half-locked state (step S160).

In the lock-releasing control in step S150, as in step S100, the closer motor 23 is controlled to rotate the sector gear of the drive mechanism 25 in the one direction described above by the predetermined angle. Accordingly, when the process of step S150 is started, the pole 22 is rotated in the counterclockwise direction in FIGS. 5 to 7 around the rotation shaft 22a by the closer motor 23 via the drive mechanism 25. The opening control of the opening and closing drive device 30 is to control the electric motor of the opening and closing drive device 30 so as to move the lid 4 to an opening side. The opening control may be the voltage gradual change process of gradually increasing the voltage applied to the electric motor of the opening and closing drive device 30 with the lapse of time from the start of the process of step S150, or may be a process of stopping the lid 4 from moving to the opening side when a rotation amount of the electric motor reaches a predetermined value after the start of the process of step S150.

In step S160, the control device 40 executes the same determination process as step S110, and when the first time tref1 does not elapse from the release of the full-latched state, the second time tref2 does not elapse from the formation of the half-latched state, and the drive state of the closer motor 23 does not indicate that the engagement between the full-locked engagement surface 212c and the pole 22 is released (step S160: NO), the control device 40 continuously executes the lock-releasing control of the closer motor 23 and the opening control of the opening and closing drive device 30 in step S150. Then, when the first time tref1 elapses from the release of the full-latched state, when the second time tref2 elapses from the formation of the half-latched state, or when the drive state of the closer motor 23 indicates that the engagement between the full-locked engagement surface 212c and the pole 22 is released (step S160: YES), the control device 40 stops the closer motor 23 and the electric motor of the opening and closing drive device 30 (step S170, time point t15 in FIG. 10).

When the closer motor 23 and the electric motor of the opening and closing drive device 30 are stopped in step S170, the engagement portion 220 of the pole 22 biased by the pole spring is engaged with the half-locked engagement surface 212b of the latch 21 biased by the latch spring, and the lid 4 is maintained in the half-locked state in which the striker 5 is pulled-in by the first claw portion 211 of the latch 21 and slightly opened. When the half-latched state is formed, the second switch SW2 continues to output the high-level on signal thereafter. After the process of step S170, the control device 40 executes the initial position return control for controlling the closer motor 23 to return the sector gear of the drive mechanism 25 to the initial position (origin position) (step S180), and determines whether the lid 4 is in the half-locked state by the same process as steps S110 and S160 (step S190). When the lid 4 is not in the half-locked state (step S190), the control device 40 executes the process of step S150 and subsequent steps described above again.

When the lid 4 is in the half-locked state after the execution of the initial position return control in step S130 or S180 (step S140: NO, time point t20 in FIG. 9, step S180: YES, time point t20′ in FIG. 10), the control device 40 starts the lock-releasing control of the closer motor 23 (step S200), and determines whether the lid 4 is in the lock-released state (step S210).

The lock-releasing control of the closer motor 23 in step S200 is also to control the closer motor 23 so as to rotate the sector gear of the drive mechanism 25 in the one direction described above by the predetermined angle. When the process of step S200 is started, the sector gear is returned to the initial position (origin position) by the closer motor 23 in the half-latched state in which the engagement portion 220 of the pole 22 is engaged with the half-locked engagement surface 212b of the latch 21. Accordingly, when the lock-releasing control in step S200 is started, the latch 21 is rotated in the counterclockwise direction in FIGS. 5 to 7 around the rotation shaft 21a by the closer motor 23 via the drive mechanism 25, and the engagement between the half-locked engagement surface 212b and the engagement portion 220 of the pole 22 biased in the clockwise direction in FIGS. 5 to 7 around the rotation shaft 22a by the pole spring is released. Further, as shown in FIGS. 9 and 10, when the first switch SW1 detects that the half-latched state is released in response to the rotation of the latch 21, the first switch SW1 outputs the high-level on signal.

In step S210, the control device 40 determines whether a predetermined third time tref3 elapses after the first switch SW1 detects the release of the half-latched state. Further, in step S110, the control device 40 determines whether the drive state of the closer motor 23 indicates that the engagement between the half-locked engagement surface 212b and the pole 22 is released. In the present embodiment, when the value of the current applied to the closer motor 23 is increased by the predetermined value or more, the control device 40 determines that the sector gear of the drive mechanism 25 reaches the terminal end in the one direction described above and the engagement between the half-locked engagement surface 212b and the pole 22 is released.

When the third time tref3 does not elapse from the release of the half-latched state and the drive state of the closer motor 23 does not indicate that the engagement between the half-locked engagement surface 212b and the pole 22 is released (step S210: NO), the control device 40 continuously executes the lock-releasing control of the closer motor 23 in step S200. When the third time tref3 elapses from the release of the half-latched state, or when the drive state of the closer motor 23 indicates that the engagement between the half-locked engagement surface 212b and the pole 22 is released (step S210: YES), the control device 40 stops the closer motor 23 and starts the opening control of the opening and closing drive device 30 (electric motor) for opening the lid 4 (step S220, time point t30 in FIG. 9, time point t30′ in FIG. 10).

Further, the control device 40 determines whether the lid 4 is in a fully open state in response to the execution of the opening control of the opening and closing drive device 30 (step S230). When the lid 4 is not in the fully open state (step S230: NO), the control device 40 continuously executes the opening control of the opening and closing drive device 30 in step S220. When the lid 4 is fully opened, the control device 40 stops the electric motor of the opening and closing drive device 30 and starts the initial position return control of the closer motor 23 to return the sector gear of the drive mechanism 25 to the initial position (origin position) (step S240, time point t40 in FIG. 9). When the sector gear of the drive mechanism 25 returns to the initial position (origin position), the control device 40 stops the closer motor 23 and completes the series of processes in FIG. 8.

As described above, the control device 40 of the lid opening and closing system 10 controls the closer motor 23 of the lock device 20 so as to transition the lid 4 from the locked state to the lock-released state via the half-locked state in response to the opening command of the lid 4 (steps S100 to S210). Further, the control device 40 controls the electric motor of the opening and closing drive device 30 so as to pull-in the lid 4 to the closing side while the lock device 20 is operated to transition the lid 4 from the locked state to the half-locked state (step S100). Accordingly, as compared with a case where the lid 4 is pulled-in to the closing side before the release of the lock by the lock device 20 is started, it is possible to prevent an increase in the time from the issuance of the opening command of the lid 4 to the release of the lock while preventing an increase in an amount of pulling-in of the lid 4 to the closing side and the acceleration. Further, by pulling-in the lid 4 to the closing side by the opening and closing drive device 30, a force applied to the lid 4 from a weather strip (elastic body) 8 or the latch spring disposed between the lid 4 and the vehicle body 2 can be reduced, and generation of abnormal noise such as collision noise between members can be prevented. As a result, according to the lid opening and closing system 10, it is possible to quickly release the lock of the lid 4 openably and closably supported by a front portion of the vehicle body 2 while preventing the generation of the abnormal noise.

The lock device 20 includes the latch 21 that is rotatable with respect to the vehicle body 2, that is engageable with the striker 5 fixed to the lid 4, and that has the full-locked engagement surface 212c and the half-locked engagement surface 212b, the pole 22 that is rotatable with respect to the vehicle body 2 and selectively engages with the full-locked engagement surface 212c and the half-locked engagement surface 212b of the latch 21 to restrict the rotation of the latch 21, the closer motor 23, the drive mechanism 25 coupled to the closer motor 23, and the first switch SW1 and second switch SW2. The drive mechanism 25 rotates the pole 22 so as to release the engagement between the full-locked engagement surface 212c and the pole 22 and rotates the latch 21 so as to release the engagement between the half-locked engagement surface 212b and the pole 22 in response to the rotation of the closer motor 23. The first switch SW1 detects that the full-latched state in which the full-locked engagement surface 212c of the latch 21 and the engagement portion 220 of the pole 22 are engaged with each other is released after the opening command is issued. The second switch SW2 detects that the half-latched state in which the half-locked engagement surface 212b of the latch 21 and the engagement portion 220 of the pole 22 are engaged with each other is formed after the opening command is issued.

Further, the control device 40 controls the electric motor so as to rotate the pole 22 in response to the opening command of the lid 4 and controls the opening and closing drive device 30 so as to pull-in the lid 4 to the closing side (step S100), and stops the closer motor 23 and the opening and closing drive device 30 (electric motor) at any timing, more specifically, at an earliest timing among these timings when the predetermined first time tref1 elapses after the first switch SW1 detects the release of the full-latched state, when the predetermined second time tref2 elapses after the second switch SW2 detects the formation of the half-latched state, and when the drive state of the closer motor 23 indicates that the engagement between the full-locked engagement surface 212c and the pole 22 is released (step S110: YES, step S120). Accordingly, the time required to transition the lid 4 from the locked state to the half-locked state can be shortened, and the pulling-in of the lid 4 to the closing side can be ended at an appropriate timing.

After the first switch SW1 detects the release of the full-latched state and the second switch SW2 detects the formation of the half-latched state (step S110: YES), when the first switch SW1 no longer detects the release of the full-latched state and the second switch SW2 no longer detects the formation of the half-latched state (step S140: YES), the control device 40 controls the closer motor 23 to rotate the pole 22 and controls the opening and closing drive device 30 (electric motor) to move the lid 4 to the opening side (step S150). Accordingly, when the lid 4 cannot be transitioned to the half-locked state due to the load applied to the lid 4 from the snow, a baggage placed on the lid 4, or the like, the lid 4 can be quickly transitioned to the half-locked state by using the opening and closing drive device 30. Further, by the opening and closing drive device 30 moving the lid 4 to the opening side, it is possible to prevent the generation of the abnormal noise such as collision noise between members due to a load from snow or the like.

In the above embodiment, the striker 5 is provided on the lid 4 and the lock device 20 is provided on the vehicle body 2, but this disclosure is not limited thereto. That is, the striker 5 may be provided on the vehicle body 2 and the lock device 20 may be provided on the lid 4, and the latch 21 and the pole 22 may be rotatable with respect to the lid 4. Needless to say, the lid opening and closing system 10 can also be applied to an engine hood (bonnet) or the like other than the lid 4 of the front trunk 3. Further, the lock device 20 may include an electric motor that rotates the latch 21 and an electric motor that rotates the pole 22, or may include a plurality of switches that have the function of the first switch SW1. The initial position return control in step S240 in FIG. 8 may be executed in parallel with the opening control of the lid 4 in step S220 after it is determined in step S210 that the lid 4 is in the half-locked state. Further, in step S100 in FIG. 8, when an emergency switch provided in the front trunk 3 is operated, the execution of the pull-in control of the opening and closing drive device 30 may be omitted, and in step S100, the execution of the pull-in control of the opening and closing drive device 30 may be constantly omitted. It is needless to say that the invention disclosed here can also be applied to a lid opening and closing system that opens, closes and locks a lid of a rear trunk, a rear hatch gate, and the like supported on a rear portion of a vehicle body of a vehicle.

A lid opening and closing system according to this disclosure is a lid opening and closing system that opens, closes and locks a lid supported by a vehicle body of a vehicle, and the lid opening and closing system includes: a lock device configured to bring the lid into any one of a locked state, a half-locked state, and a lock-released state; an opening and closing drive device configured to open and close the lid; and a control device configured to control the lock device to transition the lid from the locked state to the lock-released state via the half-locked state in response to an opening command of the lid, and configured to control the opening and closing drive device to pull-in the lid toward a closing side while the lock device operates to transition the lid from the locked state to the half-locked state.

The control device of the lid opening and closing system according to this disclosure controls the lock device so as to transition the lid from the locked state to the lock-released state via the half-locked state in response to the opening command of the lid. Further, the control device controls the opening and closing drive device so as to pull-in the lid to the closing side while the lock device is operated to transition the lid from the locked state to the half-locked state. Accordingly, as compared with a case where the lid is pulled-in to the closing side before the release of the lock by the lock device is started, it is possible to prevent an increase in the time from the issuance of the opening command of the lid to the release of the lock while preventing an increase in an amount of pulling-in of the lid to the closing side and the acceleration. Further, by pulling-in the lid to the closing side by the opening and closing drive device, a force applied to the lid from an elastic body disposed between the lid and the vehicle body can be reduced, and generation of abnormal noise such as collision noise between members can be prevented. As a result, according to the lid opening and closing system of this disclosure, it is possible to quickly release the lock of the lid openably and closably supported by the vehicle body of the vehicle while preventing the generation of the abnormal noise.

Another lid opening and closing system according to this disclosure is a lid opening and closing system that opens, closes and locks a lid supported by a vehicle body of a vehicle, and the lid opening and closing system includes: a lock device configured to bring the lid into any one of a locked state, a half-locked state, and a lock-released state; an opening and closing drive device configured to open and close the lid; and a control device configured to control the lock device to transition the lid from the locked state to the lock-released state via the half-locked state in response to an opening command of the lid, configured to control the lock device to transition the lid from the locked state to the lock-released state via the half-locked state when the lid returns to the locked state again after the lock device transitions the lid from the locked state to the half-locked state, and configured to control the opening and closing drive device to transition the lid to an opening side.

The other control device of the lid opening and closing system according to this disclosure controls the lock device so as to transition the lid from the locked state to the lock-released state via the half-locked state in response to the opening command of the lid. Further, when the lid returns to the locked state again after the lock device transitions the lid from the locked state to the half-locked state, the control device controls the lock device to transition the lid from the locked state to the lock-released state via the half-locked state, and controls the opening and closing drive device to move the lid to the opening side. Accordingly, when the lid cannot be transitioned to the half-locked state due to the load applied to the lid from the snow, a baggage placed on the lid, or the like, the lid can be quickly transitioned to the half-locked state by using the opening and closing drive device. Further, by the opening and closing drive device moving the lid to the opening side, it is possible to prevent the generation of the abnormal noise such as collision noise between members due to a load from snow or the like. As a result, according to the other lid opening and closing system of this disclosure, it is possible to quickly release the lock of the lid openably and closably supported by the vehicle body of the vehicle while preventing the generation of the abnormal noise.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

### INDUSTRIAL APPLICABILITY

The invention disclosed here can be used in a manufacturing industry or the like of a vehicle.

What is claimed is:

1. A lid opening and closing system that opens, closes and locks a lid supported by a vehicle body of a vehicle, the lid opening and closing system comprising:
a lock device configured to bring the lid into any one of a locked state, a half-locked state, and a lock-released state;
an opening and closing drive device configured to open and close the lid; and
a control device configured to control the lock device to transition the lid from the locked state to the lock-released state via the half-locked state in response to an opening command of the lid, and configured to control the opening and closing drive device to pull-in the lid toward a closing side while the lock device operates to transition the lid from the locked state to the half-locked state.

2. The lid opening and closing system according to claim 1, wherein
the lock device includes
a latch configured to rotate with respect to one of the lid and the vehicle body, configured to engage with a striker fixed to the other one of the lid and the vehicle body, and including a full-locked engagement portion and a half-locked engagement portion,
a pole configured to rotate with respect to the one of the lid and the vehicle body and configured to be selectively engaged with the full-locked engagement portion and the half-locked engagement portion of the latch to restrict rotation of the latch,
a motor,
a drive mechanism coupled to the motor, configured to rotate the pole so as to release the engagement between the full-locked engagement portion and the pole, and configured to rotate the latch so as to release the engagement between the half-locked engagement portion and the pole in response to rotation of the motor,
a first switch configured to detect that a full-latched state in which the full-locked engagement portion of the latch is engaged with the pole is released after the opening command is issued, and
a second switch configured to detect that a half-latched state in which the half-locked engagement portion of the latch is engaged with the pole is formed after the opening command is issued, and
the control device controls the motor so as to rotate the pole in response to the opening command and controls the opening and closing drive device so as to pull-in the lid to the closing side, and stops the motor and the opening and closing drive device at any one of timings when a predetermined first time elapses after the first switch detects the release of the full-latched state, when a predetermined second time elapses after the second switch detects the formation of the half-latched state, and when a drive state of the motor indicates that the engagement between the full-locked engagement portion and the pole is released.

3. The lid opening and closing system according to claim 2, wherein
after the first switch detects the release of the full-latched state and the second switch detects the formation of the half-latched state, when the first switch no longer detects the release of the full-latched state and the second switch no longer detects the formation of the half-latched state, the control device controls the motor to rotate the pole and controls the opening and closing drive device to move the lid to the opening side.

4. A lid opening and closing system that opens, closes and locks a lid supported by a vehicle body of a vehicle, the lid opening and closing system comprising:
a lock device configured to bring the lid into any one of a locked state, a half-locked state, and a lock-released state;
an opening and closing drive device configured to open and close the lid; and
a control device configured to control the lock device to transition the lid from the locked state to the lock-released state via the half-locked state in response to an opening command of the lid, configured to control the lock device to transition the lid from the locked state to the lock-released state via the half-locked state when the lid returns to the locked state again after the lock device transitions the lid from the locked state to the half-locked state, and configured to control the opening and closing drive device to move the lid to an opening side.
